(19) United States
(12) Patent Application Publication
(10) Pub. No.: US 2025/0158712 A1
(43) Pub. Date: May 15, 2025

(54) OPTICAL RECEIVE DEVICE AND OPTICAL TRANSMISSION SYSTEM

(71) Applicant: Fujitsu Limited, Kawasaki-shi (JP)

(72) Inventors: Yo Nakamura, Yokohama (JP); Hisao NAKASHIMA, Kawasaki (JP); GUOXIU HUANG, Kawasaki (JP)

(73) Assignee: Fujitsu Limited, Kawasaki-shi (JP)

(21) Appl. No.: 18/925,913

(22) Filed: Oct. 24, 2024

(30) Foreign Application Priority Data
Nov. 10, 2023 (JP) 2023-192482

(51) Int. Cl. H04B 10/2513; H04B 10/61

(52) U.S. Cl. CPC H04B 10/2513; H04B 10/616

(57) ABSTRACT

An optical receive device includes a coherent receiver that outputs an electrical analog signal corresponding to an optical signal, a converter that converts the electrical analog signal into a digital signal, a scrambler that scrambles a differential group delay (DGD) of the digital signal, and an adjustment unit that receives the digital signal output by the scrambler as an input and adjusts one or both of a sampling frequency and a sampling phase of the converter based on a power envelope (PE) method.

### CROSS-REFERENCE TO RELATED APPLICATION

This application is based upon and claims the benefit of priority of the prior Japanese Patent Application No. 2023-192482, filed on Nov. 10, 2023, the entire contents of which are incorporated herein by reference.

### FIELD

A certain aspect of embodiments described herein relates to an optical receive device and an optical transmission system.

### BACKGROUND

An optical transmission system that includes an optical transmit device and an optical receive device and transmits an optical signal through a transmission line such as an optical fiber is known as disclosed in, for example, Japanese Patent Application Laid-Open Nos. 2011-166627 and 2010-045491 (Patent Documents 1 and 2). The THP (Tomlinson-Harashima Precoding) technique is also known as a technique to compensate for intersymbol interference in a transmission line at the transmitting end as disclosed in, for example, U.S. Patent Application Publication No. 2009/0122854 (Patent Document 3).

### SUMMARY

According to an aspect of the embodiments, there is provided an optical receive device including: a coherent receiver that outputs an electrical analog signal corresponding to an optical signal; a converter that converts the electrical analog signal into a digital signal; a scrambler that scrambles a differential group delay (DGD) of the digital signal; and an adjustment unit that receives the digital signal output by the scrambler as an input and adjusts one or both of a sampling frequency and a sampling phase of the converter based on a power envelope (PE) method.

According to another aspect of the embodiments, there is provided an optical transmission system including: an optical transmit device that applies a predetermined technique for reducing intersymbol interference of a transmission line to a first digital signal and transmits an optical signal corresponding to the first digital signal, and an optical receive device that receives the optical signal, wherein the optical receive device includes: a coherent receiver that receives the optical signal and outputs an electrical analog signal corresponding to the optical signal; a converter that converts the electrical analog signal into a second digital signal; a scrambler that scrambles a differential group delay (DGD) of the second digital signal; and an adjustment unit that receives a digital signal output by the scrambler as an input and adjusts one or both of a sampling frequency and a sampling phase of the converter based on a power envelope (PE) method.

According to another aspect of the embodiments, there is provided an optical transmission system including an optical transmit device that transmits an optical signal, and an optical receive device that receives the optical signal, wherein the optical transmit device includes: a coding unit that precodes an electrical first digital signal using a predetermined technique for reducing intersymbol interference of a transmission line; an insertion unit that inserts a training sequence including a plurality of identical patterns to the first digital signal after being precoded, and a modulator that modulates, into the optical signal, the first digital signal to which the training sequence has been inserted, wherein the optical receive device includes: a coherent receiver that receives the optical signal and outputs an electrical analog signal corresponding to the optical signal, a converter that converts the electrical analog signal into a second digital signal, a sampling phase compensator that compensates for a sampling phase of the optical signal based on a coefficient updated by adaptive equalization processing on the second digital signal, a sampling frequency error estimation unit that determines a start position of the training sequence included in the second digital signal based on correlation of the identical patterns before compensating for the sampling phase, and estimates a sampling frequency error of the converter based on a difference between a first sample number based on the start position and a second sample number of the training sequency at the optical transmit device or a sample number ratio between the first sample number and the second sample number.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an example of an optical transmission system.

FIG. 2 illustrates an example of an optical receive device according to a first embodiment.

FIG. 3 illustrates an example of a sampling phase synchronization unit according to the first embodiment.

FIG. 4 illustrates an example of a first digital loop filter (first DLF).

FIG. 5 illustrates an example of a second DLF.

FIG. 6 illustrates an example of a sampling phase compensation unit.

FIG. 7 illustrates an example of a decimal part correction unit.

FIG. 8 illustrates an example of an initial sampling phase error estimation unit.

FIG. 9 illustrates an example of a PE-type sampling phase error detector.

FIG. 10A illustrates an example of a differential group delay (DGD) scrambler, and

FIG. 10B illustrates an example of a transfer function of polarization rotation and an example of a transfer function of the DGD.

FIG. 11A illustrates another example (No. 1) of the DGD scrambler, and FIG. 11B illustrates another example (No. 2) of the DGD scrambler.

FIG. 12 is a diagram for describing the effects of comparative examples and an example.

FIG. 13 illustrates an example of an optical transmit device according to a second embodiment.

FIG. 14 illustrates an example of a sampling phase synchronization unit according to the second embodiment.

FIG. 15 illustrates an example of an initial sampling frequency error estimation unit.

FIG. 16 is a diagram for describing an example of determining a training sequence (TS) start position.

FIG. 17 is a diagram for describing an example of a difference between a TS reference position and the TS start position.

FIG. 18 is a diagram for describing an example of a mismatch between the sampling frequency at the time of transmission and the sampling frequency at the time of reception.

### DESCRIPTION OF EMBODIMENTS

The THP technique described above is implemented in a digital signal processor (DSP) or the like included in an optical transmit device. A DSP with the THP technique implemented performs the THP on digital signals input to the DSP. Thus, the intersymbol interference is compensated in advance before the optical receive device receives the optical signal. The optical transmit device converts the digital signal on which the THP is executed into an optical signal and transmits the optical signal to the transmission line. The optical receive device receives the optical signal from the transmission line and converts the optical signal into a digital signal.

Here, the optical receive device performs sampling to acquire a part of the analog signal and convert the part into a digital signal. The analog signal periodically includes pulses, that is, symbols, representing transmission data. To maximize the signal quality, it is necessary to convert the peak of each symbol into a digital signal, and it is necessary to match the timing at which the symbol arrives at the optical receive device with the timing at which sampling is executed. The timing at which each symbol arrives at the optical receive device, that is, the timing at which sampling is actually executed within one symbol interval with reference to the ideal sampling timing is referred to as a sampling phase. The optical receive device has a mechanism for detecting a sampling phase error and compensating for the error in some way in order to always maintain ideal sampling timing. This improves the signal quality of the digital signal.

However, when the THP is executed in the optical transmit device, the regularity of the signal waveform of the digital signal is lost in the optical receive device because of the THP, and the detection accuracy of the sampling phase error is reduced. This increases the difference between the sampling timing determined by the optical receive device and the ideal sampling timing. As a result, the signal quality of the digital signal may be degraded.

Hereinafter, embodiments for carrying out the present disclosure will be described with reference to the drawings.

### First Embodiment

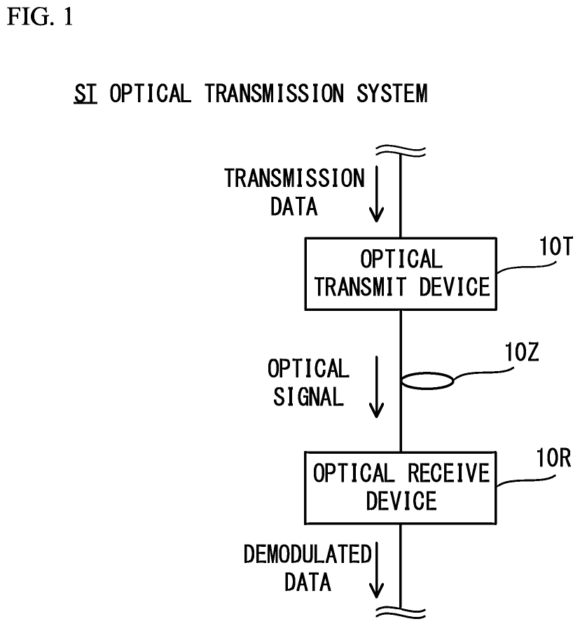

As illustrated in FIG. 1, an optical transmission system ST includes an optical transmit device 10T and an optical receive device 10R. The optical receive device 10R includes a digital coherent receiver. The optical transmit device 10T and the optical receive device 10R are connected by a transmission line 10Z such as an optical fiber. A repeater such as an optical amplifier may be provided in the transmission line 10Z. When transmission data is input, the optical transmit device 10T transmits an optical signal modulated based on the transmission data to the transmission line 10Z. The optical signal propagates through the transmission line 10Z. The optical receive device 10R receives the optical signal transmitted from the optical transmit device 10T through the transmission line 10Z and demodulates the optical signal, and outputs the demodulated data corresponding to the optical signal.

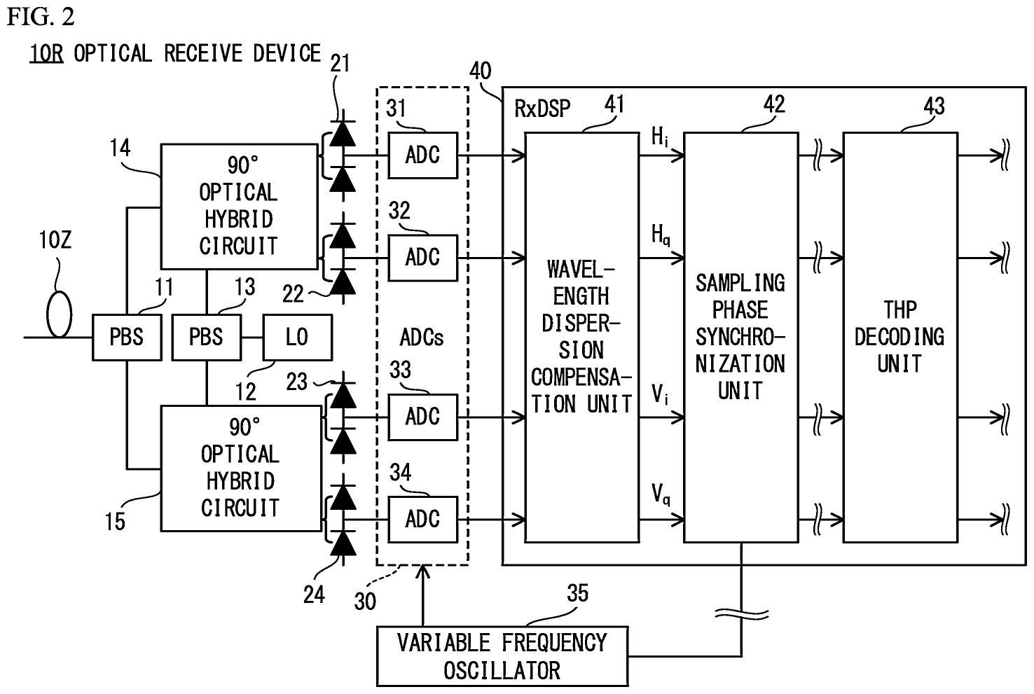

The optical receive device 10R will be described in detail with reference to FIG. 2.

When the optical receive device 10R receives an optical signal from the transmission line 10Z, the optical signal is input to a polarization beam splitter (PBS) 11. The PBS 11 separates the optical signal into an H-axis polarization component (horizontal polarization component) and a V-axis polarization component (vertical polarization component). The H-axis polarization component is input to a 90° optical hybrid circuit 14. The V-axis polarization component is input to a 90° optical hybrid circuit 15. Local oscillation light output from a local oscillator (LO) 12 is separated by a PBS 13. The local oscillation light is input to each of the 90° optical hybrid circuits 14 and 15.

The 90° optical hybrid circuit 14 detects the H-axis polarization component by using the local oscillation light, outputs the interference component (I component) in the same phase to a balanced photo diode (BPD) 21 as a photoelectric transducer, and outputs the interference component (Q component) with a phase shift of 90° to a BPD 22. The 90° optical hybrid circuit 15 detects the V-axis polarization component using the local oscillation light, outputs the interference component (I component) in the same phase to a BPD 23, and outputs the interference component (Q component) with a phase shift of 90° to a BPD 24. As described above, the 90° optical hybrid circuits 14 and 15 separate the optical signal into optical signals of four channels in total, i.e., the H-axis polarization I component, the H-axis polarization Q component, the V-axis polarization I component, and the V-axis polarization Q component, and outputs the optical signals to the corresponding BPDs 21, 22, 23, and 24. The digital coherent receiver is implemented by the PBSs 11 and 13, the 90° optical hybrid circuits 14 and 15, and the BPDs 21, 22, 23, and 24.

Each of the BPDs 21, 22, 23, and 24 converts the input optical signal into an electrical analog signal. Each analog signal is input to a corresponding one of analog digital converters (ADCs) 31, 32, 33, and 34 in an ADCs 30. Each of the ADCs 31, 32, 33, and 34 performs digital sampling at sampling timing synchronized with the sampling frequency output from a variable frequency oscillator 35. For example, each of the ADCs 31, 32, 33, and 34 performs sampling twice (double oversampling) per symbol.

Thus, the analog value of each analog signal is converted into a digital value, and the digital values are developed in parallel to a clock speed that can be achieved by a large-scale integration (LSI) such as a complementary metal-oxide-semiconductor (CMOS). The respective digital signals of the H-axis polarization I component, the H-axis polarization Q component, the V-axis polarization I component, and the V-axis polarization Q component are input to a receiving-end DSP (denoted by RxDSP in FIG. 2) 40. The variable frequency oscillator 35 includes, for example, a low pass filter (LPF), a voltage controlled oscillator (VCO), and the like.

The receiving-end DSP 40 includes a wavelength dispersion compensation unit 41, a sampling phase synchronization unit 42, a THP decoding unit 43, and the like. The sampling phase synchronization unit 42 is an example of an adjustment unit that receives a digital signal output from the DGD scrambler 563, which will be described later as an input, and adjusts one or both of the sampling frequency and the sampling phase of the ADCs 30 based on the PE method. The THP decoding unit 43 is an example of a decoding unit that decodes a digital signal precoded based on the THP technique. Although not illustrated in FIG. 2, the receiving-end DSP 40 includes, for example, an error correction decoding unit that demodulates a digital signal and outputs the demodulated signal, at a stage subsequent to the THP decoding unit 43. The wavelength dispersion compensation unit 41, the sampling phase synchronization unit 42, the THP decoding unit 43, and the like may be implemented by a single DSP or may be implemented by individual DSPs, respectively.

The wavelength dispersion compensation unit 41 estimates waveform distortion of the optical signal due to wavelength dispersion based on the respective digital signals output from the ADCs 31, 32, 33, and 34, and compensates for the waveform distortion due to the wavelength dispersion. The sampling phase synchronization unit 42 performs digital phase compensation on each digital signal in which the waveform distortion due to the wavelength dispersion is compensated, and outputs the digital signals to the subsequent stage. Along with this, the sampling phase synchronization unit 42 feeds back the detection result of the sampling phase error of each input digital signal to the variable frequency oscillator 35 to compensate for the frequency errors of the ADCs 31, 32, 33, and 34. The sampling phase error represents the magnitude and direction of the timing error between the ideal sampling timing and the actual sampling timing for the symbol phase of the digital signal in the ADCs 30. The direction of the timing error is, for example, the advance or delay of the sampling timing that can be expressed by a positive or negative sign. Digital phase compensation and ADC frequency control provide clock recovery that always maintains ideal sampling timing of the signal. The THP decoding unit 43 decodes digital signals Hᵢ, H_{q}, Vᵢ, and V_{q} precoded by a THP processing unit to be described later.

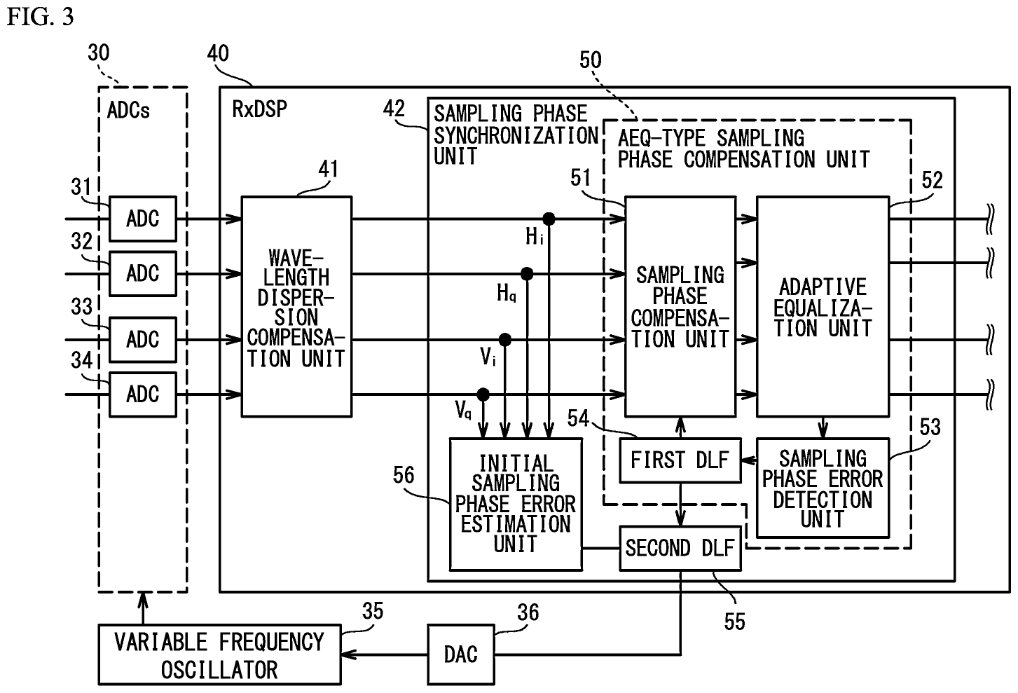

The details of the sampling phase synchronization unit 42 will be described with reference to FIG. 3.

The sampling phase synchronization unit 42 includes an adaptive equalizer (AEQ)-type sampling phase compensation unit 50. The AEQ-type sampling phase compensation unit 50 is an example of a sampling phase compensator. The AEQ-type sampling phase compensation unit 50 includes a sampling phase compensation unit 51, an adaptive equalization unit 52, a sampling phase error detection unit 53, and a first DLF 54. In addition, the sampling phase synchronization unit 42 includes a second DLF 55 and an initial sampling phase error estimation unit 56.

Each digital signal whose waveform distortion due to the wavelength dispersion is compensated by the wavelength dispersion compensation unit 41 is input to the AEQ-type sampling phase compensation unit 50. As will be described later, the sampling phase compensation unit 51 of the AEQ-type sampling phase compensation unit 50 adjusts the sampled digital signals to have the sampling phase that the sampled digital signals are to be in, by shifting the input positions of the digital signals input in parallel. In this manner, clock recovery is performed based on the sampling phase error by the sampling phase compensation unit 51. Each digital signal whose sampling phase has been compensated is output to the adaptive equalization unit 52.

The adaptive equalization unit 52 performs adaptive equalization type waveform distortion compensation as adaptive equalization processing on each digital signal output from the sampling phase compensation unit 51. For example, the adaptive equalization unit 52 compensates for waveform distortion caused by polarization mode dispersion (PMD). The adaptive equalization unit 52 can be implemented by an adaptive equalizer in which an algorithm such as a constant modulus algorithm (CMA) is implemented and a 2×2 multi-input multi-output (MIMO)-type finite impulse response (FIR) filter.

The sampling phase error detection unit 53 calculates a group delay value, which is an average delay time of the 2×2 MIMO-type FIR filter, based on the tap coefficient updated by the adaptive equalization processing. The group delay value can be calculated by converting the coefficient of the FIR filter into a frequency domain and obtaining the differential of its phase characteristics. By calculating the group delay value, the sampling phase error detection unit 53 detects the sampling phase error in the ADCs 30, and generates a sampling phase error signal.

When the sampling phase error detection unit 53 generates the sampling phase error signal, the sampling phase error detection unit 53 outputs the sampling phase error signal to the first DLF 54. In this manner, the AEQ-type sampling phase compensation unit 50 can detect the sampling phase error based on the group delay value.

The first DLF 54 processes the sampling phase error signal output from the sampling phase error detection unit 53. The first DLF 54 includes a low pass filter (LPF), which will be described in detail later. Therefore, the first DLF 54 can remove noise from the sampling phase error signal as signal processing. The first DLF 54 outputs the signal-processed sampling phase error signal to the sampling phase compensation unit 51 as a sampling phase compensation amount. The first DLF 54 outputs the signal-processed sampling phase error signal to the second DLF 55 as the sampling phase error compensation amount.

The second DLF 55 signal-processes the sampling phase compensation amount output from the first DLF 54. The signal process performed by the second DLF 55 is, for example, to perform temporal variation, i.e., temporal differentiation of the sampling phase error, and to calculate the frequency error from the sampling phase compensation amount. The second DLF 55 outputs the signal-processed sampling phase compensation amount to a digital analog converter (DAC) 36 as a frequency control signal. Thus, the frequency control signal is converted from a digital format to an analog format and is input to the variable frequency oscillator 35. The variable frequency oscillator 35 compensates for the frequency error between the optical signal and sampling by varying the frequency of the clock output from the variable frequency oscillator 35 based on the frequency control signal output from the DAC 36.

Here, a part of the digital signal before the sampling phase is compensated by the sampling phase compensation unit 51 is input to the initial sampling phase error estimation unit 56. The initial sampling phase error estimation unit 56 estimates the amount of sampling phase error of the digital signal in the initial period (for example, at the start of operation or at the restart of the optical receive device 10R), which will be described in detail later. When the initial sampling phase error estimation unit 56 estimates the amount of sampling phase error, the initial sampling phase error estimation unit 56 outputs the amount of sampling phase error to the second DLF 55.

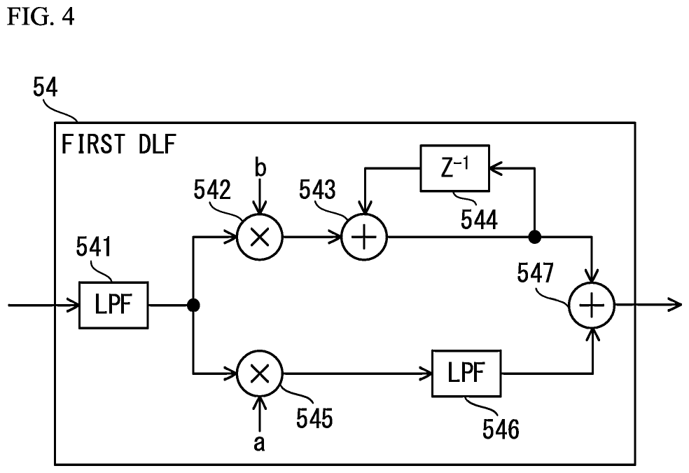

Details of the first DLF 54 will be described with reference to FIG. 4.

The first DLF 54 includes an LPF 541, a multiplier circuit 542, an adder circuit 543, a delay element 544, a multiplier circuit 545, an LPF 546, and an adder circuit 547. The sampling phase error signal output from the sampling phase error detection unit 53 is input to the LPF 541. The LPF 541 extracts the low frequency component of the input sampling phase error signal and outputs the extracted signal to the multiplier circuit 542 and the multiplier circuit 545.

The multiplier circuit 542 multiplies the signal output from the LPF 541 by a coefficient b and outputs the result to the adder circuit 543. The adder circuit 543 adds the signal output from the delay element 544 to the signal output from the multiplier circuit 542, and outputs the added signal as an integral term to the delay element 544 and the adder circuit 547. The delay element 544 delays the signal output from the adder circuit 543 by one operation clock of the first DLF 54, and outputs the delayed signal to the adder circuit 543.

The multiplier circuit 545 multiplies the signal output from the LPF 541 by a coefficient a and outputs the result to the LPF 546. The LPF 546 extracts the low-frequency component of the signal output from the multiplier circuit 545, and outputs the extracted signal as a proportional term to the adder circuit 547. The adder circuit 547 adds the signal of the integral term output from the adder circuit 543 and the signal of the proportional term output from the LPF 546. The adder circuit 547 outputs the added signal to each of the sampling phase compensation unit 51 and the second DLF 55 as the sampling phase compensation amount.

With the above configuration, the sampling phase error signal input to the first DLF 54 is converted into the sampling phase error compensation amount as the sum of the proportional term and the integral term having the coefficients a and b. The coefficients a and b are determined according to, for example, the design of the optical receive device 10R and the transmission conditions.

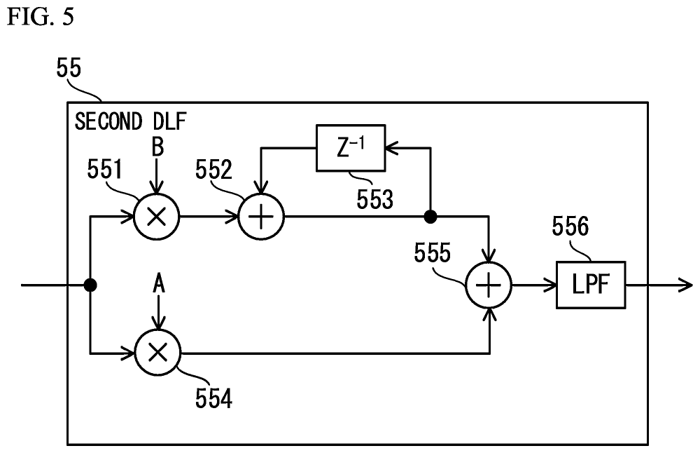

Details of the second DLF 55 will be described with reference to FIG. 5.

The second DLF 55 includes a multiplier circuit 551, an adder circuit 552, a delay element 553, a multiplier circuit 554, an adder circuit 555, and an LPF 556. The signals such as the sampling phase compensation amount and the sampling phase error amount input to the second DLF 55 are input to each of the multiplier circuit 551 and the multiplier circuit 554.

The multiplier circuit 551 multiplies the input signal by a coefficient B and outputs the result to the adder circuit 552. The adder circuit 552 adds the signal output from the delay element 553 to the signal output from the multiplier circuit 551, and outputs the added signal as an integral term to each of the delay element 553 and the adder circuit 555. The delay element 553 delays the signal output from the adder circuit 552 by one operation clock of the second DLF 55, and outputs the delayed signal to the adder circuit 552.

The multiplier circuit 554 multiplies the input signal by a coefficient A and outputs the multiplied signal as a proportional term to the adder circuit 555. The adder circuit 555 adds the signal of the integral term output from the adder circuit 552 and the signal of the proportional term output from the multiplier circuit 554, and outputs the result to the LPF 556. The LPF 556 extracts the low-frequency component of the signal output from the adder circuit 555, and outputs the extracted signal to the DAC 36 as a frequency control signal.

With the above configuration, the signal input to the second DLF 55 is converted into the frequency control signal as the sum of the proportional term and the integral term having the coefficients A and B. The coefficients A and B are determined according to, for example, the design of the optical receive device 10R and the transmission conditions.

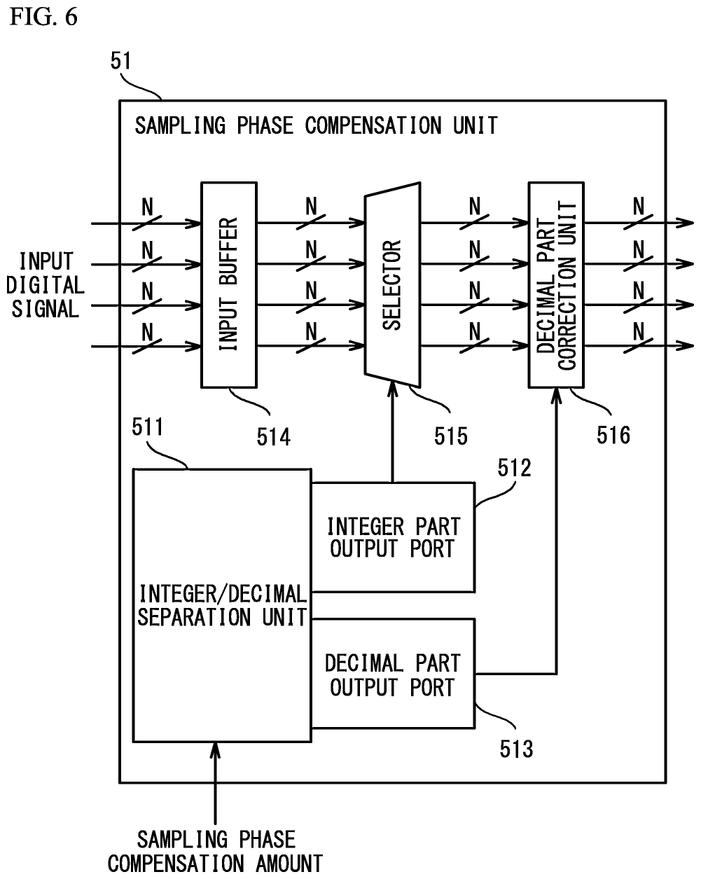

The details of the sampling phase compensation unit 51 will be described with reference to FIG. 6.

The sampling phase compensation unit 51 includes an integer/decimal separation unit 511, an integer part output port 512, a decimal part output port 513, an input buffer 514, a selector 515, and a decimal part correction unit 516. The integer/decimal separation unit 511 separates the input sampling phase compensation amount into an integer value and a fractional value in units of samples. That is, the integer/decimal separation unit 511 separates the sampling phase compensation amount into the integer value and the fractional value of the value obtained by dividing the sampling phase compensation amount by the sampling period. The integer part output port 512 supplies the integer value to the selector 515. The decimal part output port 513 supplies the fractional value to the decimal part correction unit 516.

The input digital signals, that is, the digital signals that are expanded in parallel into N signals in each channel and in which the waveform distortion due to the wavelength dispersion is compensated, are input to the selector 515 via the input buffer 514. The selector 515 barrel-shifts the digital signals expanded in parallel by the integer value (the number of samples) calculated from the sampling phase compensation amount. The decimal part correction unit 516 adjusts the phase of less than one sample in the frequency domain, for example.

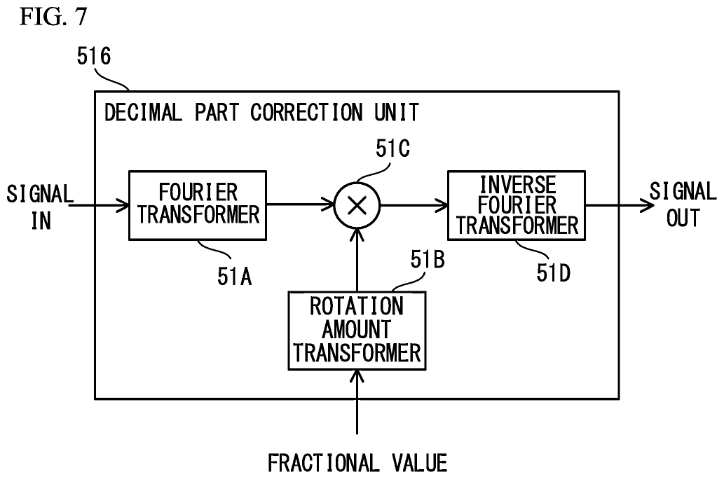

The decimal part correction unit 516 will be described in detail with reference to FIG. 7.

The decimal part correction unit 516 includes a Fourier transformer 51A, a rotation amount transformer 51B, a multiplier 51C, and an inverse Fourier transformer 51D. The Fourier transformer 51A converts the input time-domain digital signal into a frequency-domain digital signal by fast Fourier transform (FFT), and outputs the frequency-domain digital signal to the multiplier 51C. On the other hand, the rotation amount transformer 51B generates a phase shift coefficient corresponding to the decimal part phase based on the fractional value of the sampling phase compensation amount, and outputs the generated phase shift coefficient to the multiplier 51C.

The multiplier 51C multiplies the frequency-domain digital signal output from the Fourier transformer 51A by the phase shift coefficient output from the rotation amount transformer 51B, and outputs the multiplication result to the inverse Fourier transformer 51D. The inverse Fourier transformer 51D converts the frequency-domain digital signal output from the multiplier 51C into a time-domain digital signal by inverse FFT (IFFT) and outputs the time-domain digital signal. Thus, the inverse Fourier transformed digital signal is output from the sampling phase compensation unit 51. In this manner, the sampling phase compensation unit 51 compensates for the sampling phase of the input digital signal based on the sampling phase compensation amount fed back from the sampling phase error detection unit 53 via the first DLF 54.

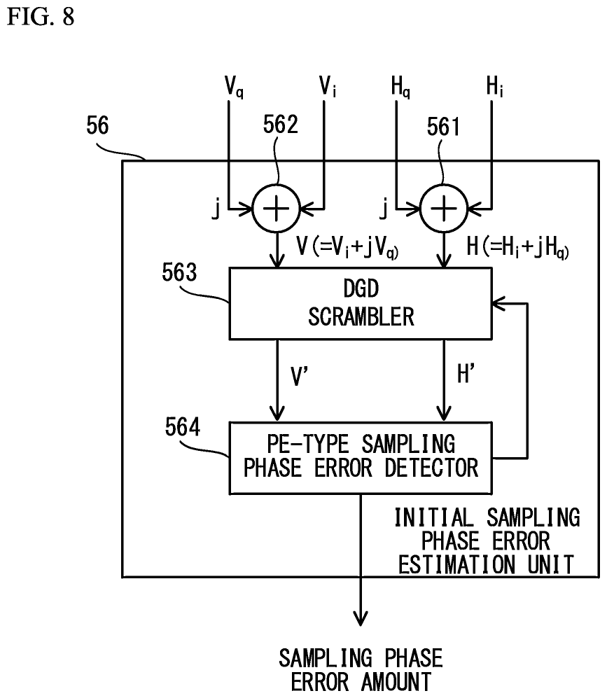

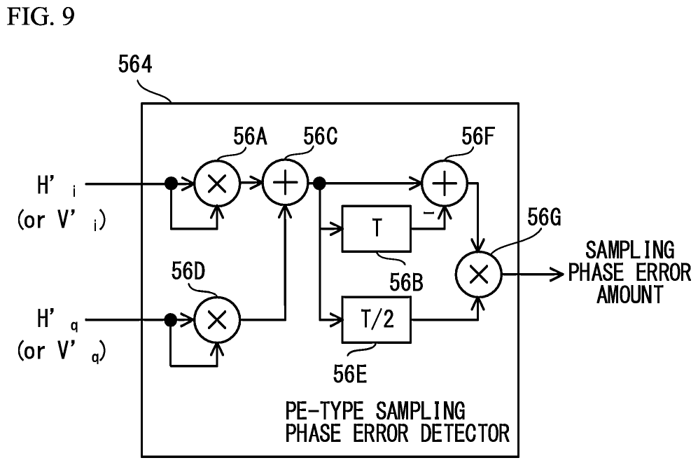

The details of the initial sampling phase error estimation unit 56 will be described with reference to FIG. 8 and FIG. 9.

As described above, the initial sampling phase error estimation unit 56 estimates the initial sampling phase error amount. The initial sampling phase error estimation unit 56 includes two adder circuits 561 and 562 arranged in parallel, a DGD scrambler 563, and a PE-type sampling phase error detector 564.

The adder circuit 561 draws in the digital signal Hᵢ representing the I component of the H-axis polarization and the digital signal H_{q} representing the Q component of the H-axis polarization, and adds the digital signal Hᵢ and the digital signal H_{q} with the imaginary unit j added. As a result, the adder circuit 561 outputs the digital signal H as the result of addition. The adder circuit 562 draws in the digital signal Vᵢ representing the I component of the V-axis polarization and the digital signal V_{q} representing the Q component of the V-axis polarization, and adds the digital signal Vᵢ and the digital signal V_{q} with the imaginary unit j added. As a result, the adder circuit 562 outputs the digital signal V as the result of addition. The digital signals Hᵢ, H_{q}, Vᵢ, and V_{q} correspond to the electric field information of the optical signal.

The DGD scrambler 563 changes the polarization rotation and the DGD values of the digital signal H and the digital signal V at random in time. The DGD scrambler 563 outputs the digital signal H, which has been subjected to polarization rotation and DGD value change, as a digital signal H′. Similarly, the DGD scrambler 563 outputs the digital signal V, which has been subjected to polarization rotation and DGD value change, as a digital signal V′. The digital signal H′ and the digital signal V′ are examples of predetermined signals. The circuit configuration of the DGD scrambler 563 and other details will be described in detail later.

The PE-type sampling phase error detector 564 detects a sampling phase error using the I component and the Q component for each of the digital signal H′ and the digital signal V′ based on the PE method. When the detection sensitivity or accuracy of the sampling phase error is low, the PE-type sampling phase error detector 564 excludes the detected sampling phase error and calculates the sampling phase error amount. The PE-type sampling phase error detector 564 may feedback a part of the sampling phase error amount to the DGD scrambler 563.

Here, the PE method is a method of controlling the power P of a signal so that an error e in the following equation (1) is minimized (desirably, 0 (zero)). The power P of the signal corresponds to the sum of the square of the I component and the square of the Q component. For the PE method, for example, the following Non-Patent Document 1 can be referred to.

$$e = {\sum }_{k = 1}^{m} ( {{I}_{2 k}}^{2} + {{Q}_{2 k}}^{2} ) \{ ( {{I}_{2 k + 1}}^{2} + {{Q}_{2 k + 1}}^{2} ) - ( {{I}_{2 k - 1}}^{2} + {{Q}_{2 k - 1}}^{2} ) \} \qquad ( 1 )$$

Non-Patent Document 1: Meng Yan et al., “Digital Clock Recovery Algorithm for Nyquist Signal”, 2013 Optical Fiber Communication Conference and Exposition and the National Fiber Optic Engineers Conference (OFC/NFOEC), Anaheim, CA, 2013.

As illustrated in FIG. 9, the PE-type sampling phase error detector 564 includes a multiplier circuit 56A, a delay element 56B, an adder circuit 56C, a multiplier circuit 56D, a delay element 56E, an adder circuit 56F, and a multiplier circuit 56G. Although the digital signal H′is used as an example in the description, the same basically applies to the digital signal V′.

The multiplier circuit 56A squares the I-component of the digital signal H′ input to the PE-type sampling phase error detector 564. The multiplier circuit 56A outputs the digital signal H′ obtained by squaring the I-component to the adder circuit 56C. The multiplier circuit 56D squares the Q-component of the digital signal H′input to the PE-type sampling phase error detector 564. The multiplier circuit 56D outputs the digital signal H′ obtained by squaring the Q-component to the adder circuit 56C.

The adder circuit 56C adds the digital signal H′ output from the multiplier circuit 56D to the digital signal H′ output from the multiplier circuit 56A, and outputs the result to the delay elements 56B and 56E and the adder circuit 56F. The delay element 56B delays the digital signal H′ output from the adder circuit 56C by one operation clock (or one symbol) of the PE-type sampling phase error detector 564, and outputs the delayed digital signal H′ to the adder circuit 56F.

The delay element 56E delays the digital signal H′ output from the adder circuit 56C by ½ of the operation clock (or ½ of the symbol) of the PE-type sampling phase error detector 564, and outputs the delayed digital signal H′ to the multiplier circuit 56G. The adder circuit 56F subtracts the digital signal H′ output from the delay element 56B from the digital signal H′ output from the adder circuit 56C, and outputs the result to the multiplier circuit 56G.

The multiplier circuit 56G multiplies the digital signal H′ output from the adder circuit 56F by the digital signal H′ output from the delay element 56E, and outputs the multiplication result as the sampling phase error amount from the PE-type sampling phase error detector 564.

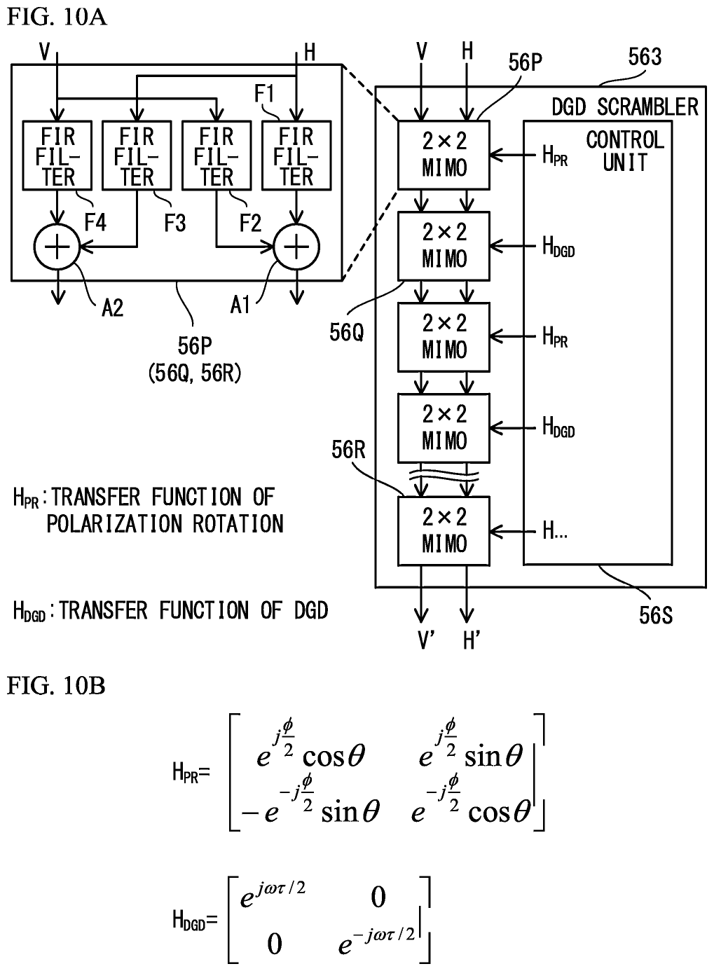

The DGD scrambler 563 will be described in detail with reference to FIG. 10A and FIG. 10B.

As illustrated in FIG. 10A, the DGD scrambler 563 includes a plurality of MIMO filters 56P, 56Q, . . . , 56R and a control unit 56S. The MIMO filters 56P, 56Q, . . . , 56R are connected in series. For example, the MIMO filter 56Q is arranged at the subsequent stage of the MIMO filter 56P to which the digital signal H and the digital signal V are input. The MIMO filter 56R that outputs the digital signal H′ and the digital signal V′is arranged at the last stage of the DGD scrambler 563. The DGD scrambler 563 is only required to include at least one of the MIMO filter 56P or the MIMO filter 56Q.

The MIMO filters 56P, 56Q, . . . , 56R have the same circuit configuration. For example, the MIMO filter 56P includes four FIR filters F1, F2, F3, and F4 and two adder circuits A1 and A2. The digital signal His input to each of the FIR filters F1 and F3. The digital signal V is input to each of the FIR filters F2 and F4. A transfer function described later is set in each of the FIR filters F1, F2, F3, and F4. The FIR filters F1 and F3 process the digital signal H based on the set transfer function, and the FIR filters F2 and F4 process the digital signal V based on the set transfer function.

The adder circuit A1 adds the digital signal H output from the FIR filter F1 and the digital signal V output from the FIR filter F2, and outputs a digital signal corresponding to the result of addition. The adder circuit A2 adds the digital signal H output from the FIR filter F3 and the digital signal V output from the FIR filter F4, and outputs a digital signal corresponding to the result of addition.

Here, for example, the calculation result of the transfer function HPR for calculating the amount of polarization rotation is set in the MIMO filter 56P by the control unit 56S. As illustrated in FIG. 10B, the transfer function HPR can be represented by a predetermined first matrix including the polarization rotation angle θ and the inter-polarization phase difference q as polarization rotation parameters (variables).

On the other hand, the calculation result of the transfer function HDGD for calculating the amount of DGD is set in the MIMO filter 56Q by the control unit 56S, for example. The transfer function HDGD can be expressed by a predetermined second matrix including the delay time t as a DGD parameter as illustrated in FIG. 10B. The transfer function HPR and the transfer function HDGD are alternately set in the MIMO filters. Therefore, either the transfer function HPR or the transfer function HDGD is set in the MIMO filter 56R by the control unit 56S.

As described above, by changing the polarization rotation parameter and the DGD parameter at random in time, the DGD scrambler 563 outputs various kinds of digital signals H′ and digital signals V′. Then, the PE-type sampling phase error detector 564 excludes detection results with low detection sensitivity or low detection accuracy of the sampling phase error amount, and outputs the sampling phase error amount.

Although the PE-type sampling phase error detector 564 has a low DGD tolerance, the PE-type sampling phase error detector 564 can be operated instantaneously even when the sampling frequency is high, by arranging the DGD scrambler 563 in the preceding stage of the PE-type sampling phase error detector 564 and inputting various kinds of digital signals H′ and digital signals V′ to the PE-type sampling phase error detector 564.

In addition, when the PE-type sampling phase error detector 564 is employed, according to the above-described Non-Patent Document 1, even if the regularity of the signal waveform of the digital signal is lost, the decrease in the detection accuracy of the sampling phase error is reduced, compared to the Gardner method. Therefore, even when the THP is executed in the optical transmit device 10T, the difference between the sampling timing determined by the optical receive device 10R and the ideal sampling timing is reduced.

As a result, the signal-to-noise ratio of the digital signal obtained by the optical receive device 10R based on the sampling timing is improved, and degradation in the signal quality of the digital signal can be avoided. For the Gardner method, the following Non-Patent Document 2 can be referred to.

Non-Patent Document 2: GARDNER F M, “A BPSK/QPSK Timing-Error Detector for Sampled Receivers”, IEEE TRANSACTIONS ON COMMUNICATIONS, Vol. COM-34, NO. 5, pp. 423 to 429, USA, May 1986.

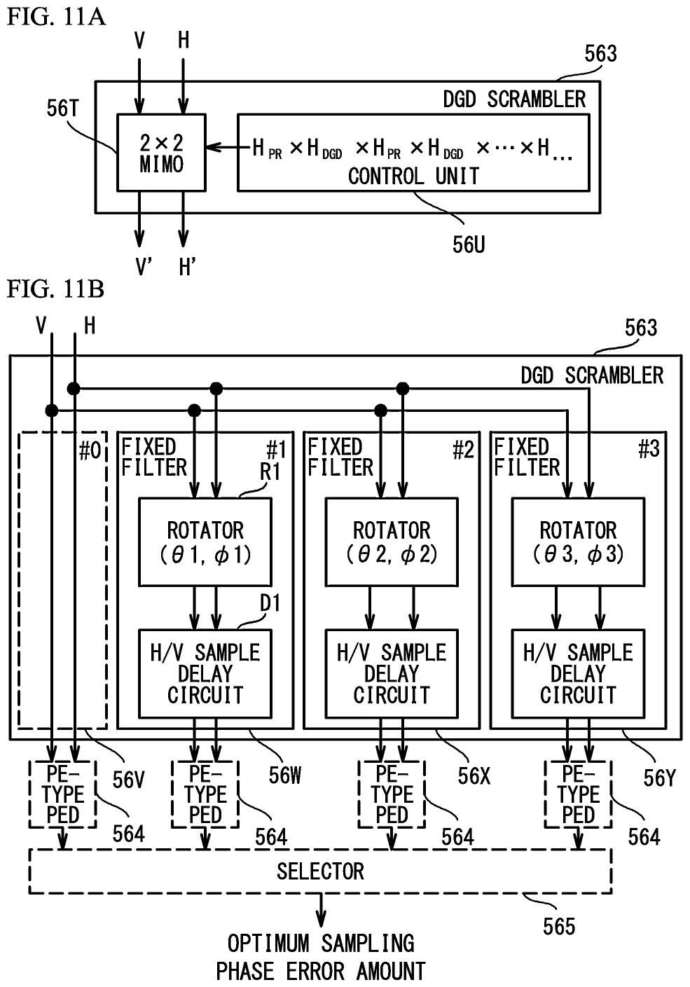

Referring to FIG. 11A and FIG. 11B, another circuit configuration different from the circuit configuration of the DGD scrambler 563 described above will be described.

First, as illustrated in FIG. 11A, the DGD scrambler 563 may include a single MIMO filter 56T and a control unit 56U. The calculation result based on the dependent product of the transfer function HPR and the transfer function H_{DGD} is set in the MIMO filter 56T by the control unit 56U. With such a circuit configuration, even when the polarization state of the input signal including the DGD is inappropriate for the operation of the PE-type sampling phase error detector 564, the PE-type sampling phase error detector 564 can be operated instantaneously.

As illustrated in FIG. 11B, the DGD scrambler 563 includes a fixed filter 56V of the arm #0, a fixed filter 56W of the arm #1, a fixed filter 56X of the arm #2, and a fixed filter 56Y of the arm #3. The fixed filters 56V, 56W, 56X, and 56Y are all equalization filters, but a fixed value as an equalization coefficient is not given to the fixed filter 56V. Therefore, the digital signal H and the digital signal V that have passed through the fixed filter 56V are output from the DGD scrambler 563.

On the other hand, a fixed value as an equalization coefficient is given to each of the fixed filters 56W, 56X, and 56Y. For example, the fixed filter 56W includes a rotator R1 and an H/V sample delay circuit D1. The polarization rotation angle θ1 and the inter-polarization phase difference φ1 are given to the rotator R1 as fixed values. Therefore, the rotator R1 rotates respective polarization axes of the input digital signal H and the input digital signal V by the polarization rotation angle θ1. The rotator R1 changes the respective inter-polarization phase differences of the input digital signal H and the input digital signal V by the inter-polarization phase difference φ1.

The DGD (or skew) of one sample for each of the digital signal H and the digital signal V is given to the H/V sample delay circuit D1. Therefore, the H/V sample delay circuit D1 changes the sample delay difference between the digital signal H and the digital signal V by one sample. The fixed filters 56X and 56Y are basically the same as the fixed filter 56W, and thus detailed description thereof will be omitted. In this manner, by setting different fixed values for the respective arms, the fixed filters 56W, 56X, and 56Y have equalization characteristics different from each other. The digital signals H and the digital signals V that have passed through the fixed filters 56W, 56X, and 56Y are output from the DGD scrambler 563.

When the DGD scrambler 563 includes such fixed filters 56V, 56W, 56X, and 56Y, the initial sampling phase error estimation unit 56 is provided with PE-type sampling phase error detectors (denoted as PE-type PED in FIG. 11B) 564 corresponding to the fixed filters 56V, 56W, 56X, and 56Y, respectively and a selector 565. As described above, when the detection sensitivity or accuracy of the sampling phase error amount is low, each of the PE-type sampling phase error detectors 564 excludes the detection result of that sampling phase error amount and outputs the sampling phase error amount.

Therefore, the selector 565 selects and outputs an optimum sampling phase error amount with high detection sensitivity and accuracy of the sampling phase error amount from among the sampling phase error amounts output from the PE-type sampling phase error detectors 564. When the DGD scrambler 563 has such a circuit configuration, even if the polarization state of the input signal including the DGD is inappropriate for the operation of the PE-type sampling phase error detector 564, the PE-type sampling phase error detector 564 can be operated instantaneously.

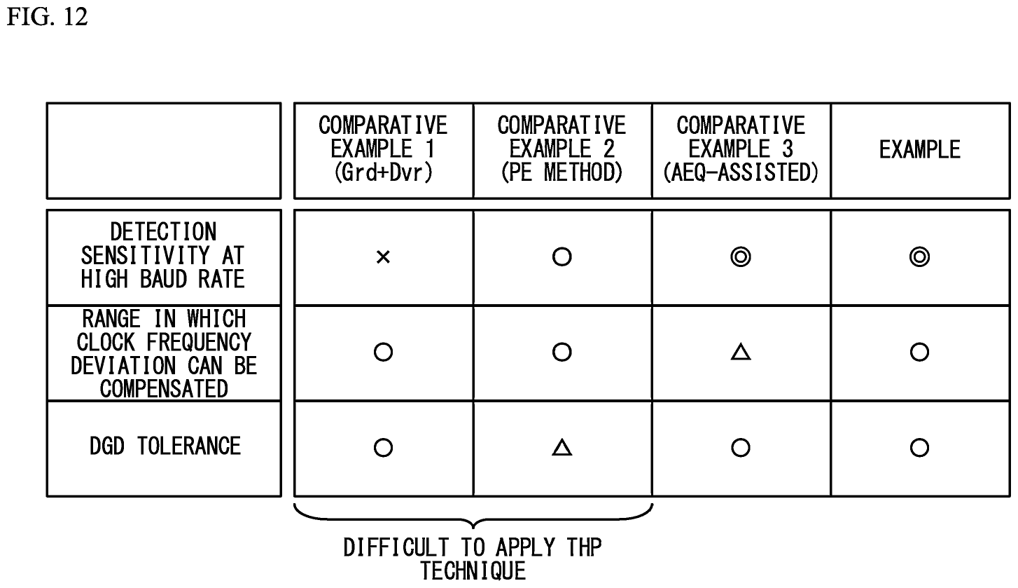

Referring to FIG. 12, the effect of the first embodiment will be described in comparison with comparative examples.

In FIG. 12, a comparative example 1 (Grd+Dvr) corresponds to a case where the Gardner method and the diversity addition are used together. A comparative example 2 (PE method) corresponds to a case where the PE-type sampling phase error detector 564 is used alone. A comparative example 3 (AEQ-assisted) corresponds to a case where the AEQ-type sampling phase compensation unit 50 is used alone without using the initial sampling phase error estimation unit 56. An example corresponds to the first embodiment in which the initial sampling phase error estimation unit 56 and the AEQ-type sampling phase compensation unit 50 are used together. As described above, the initial sampling phase error estimation unit 56 includes the DGD scrambler 563 and the PE-type sampling phase error detector 564.

First, in the case of the comparative example 1, when the THP is executed in the optical transmit device 10T, the detection sensitivity of the sampling phase error in the optical receive device 10R at the time of the high baud rate is greatly reduced. Therefore, it is extremely difficult to adopt the comparative example 1 in the optical transmission system ST to which the THP technique is applied as the predetermined technique. In the case of the comparative example 2, the DGD tolerance is not improved as much as in the comparative example 1. That is, the DGD tolerance of the comparative example 2 is equivalent to the DGD tolerance in the case where the Gardner method is used alone without using the diversity addition. Therefore, in the optical transmission system ST to which the THP technique is applied, it is also extremely difficult to adopt the comparative example 2.

In the case of the comparative example 3, the AEQ-type sampling phase compensation unit 50 detects the sampling phase error based on the tap coefficient, and thus the detection speed of the sampling phase may be slow. Therefore, if the error, that is, deviation of the sampling frequency (that is, clock frequency) is large at the start of the operation of the optical receive device 10R, the operation of the AEQ-type sampling phase compensation unit 50 may not be stable. Therefore, in the case of the comparative example 3, the range in which the deviation of the sampling frequency can be compensated is limited to a predetermined deviation range narrower than those of the comparative example 1 and the comparative example 2.

On the other hand, in the case of the example, even if the deviation of the sampling frequency is large at the start of the operation of the optical receive device 10R, the PE-type sampling phase error detector 564 is operated instantaneously by the DGD scrambler 563, and the deviation of the sampling frequency of the ADCs 30 is compensated. Specifically, the PE-type sampling phase error detector 564 works with the second DLF 55, the variable frequency oscillator 35, and the DAC 36 to control the ADCs 30 so that the sampling frequency deviation is reduced. When the deviation of the sampling frequency is reduced, the AEQ-type sampling phase compensation unit 50 can operate stably.

As described above, in the case of the example, even when the THP is executed in the optical transmit device 10T, the detection sensitivity equivalent to that of the comparative example 3 is secured even at the time of the high baud rate without being affected by the regularity of the signal waveform of the digital signal. The range in which the deviation of the sampling frequency can be compensated can be expanded to a range equivalent to that of the comparative example 1 or the comparative example 2 or a range about twice the predetermined deviation described above.

### Second Embodiment

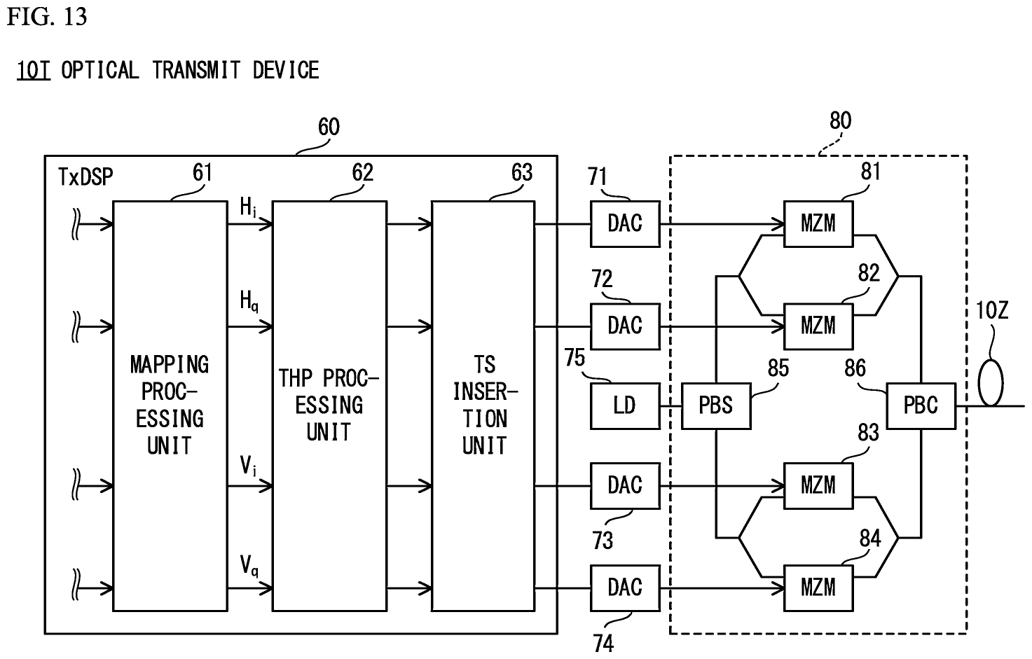

Next, a second embodiment of the present disclosure will be described with reference to FIG. 13 to FIG. 18.

First, the optical transmit device 10T according to the second embodiment will be described in detail with reference to FIG. 13. Although details will be described later, the optical transmit device 10T according to the second embodiment is different from the optical transmit device 10T according to the first embodiment.

The optical transmit device 10T according to the second embodiment generates an optical signal in which an H-axis polarization component and a V-axis polarization component orthogonal to each other are combined. The optical transmit device 10T includes a transmitting-end DSP (denoted as TxDSP in FIG. 13) 60, DACs 71, 72, 73, and 74, an laser diode (LD: transmission light source) 75, and an optical transmit unit 80.

The optical transmit unit 80 includes Mach-Zehnder modulators (MZMs) 81, 82, 83, and 84, a PBS 85, and a polarization beam combiner (PBC) 86. The optical transmit unit 80 transmits an optical signal to the transmission line 10Z.

The transmitting-end DSP 60 modulates the transmission data input from another device using a multi-level modulating method (hereinafter, referred to as a modulating method) such as a quadrature amplitude modulation (64QAM) to generate the digital signals Hᵢ, H_{q}, Vᵢ, and V_{q}, and outputs the digital signals Hᵢ, H_{q}, Vᵢ, and V_{q} to the DACs 71, 72, 73, and 74, respectively. The DACs 71, 72, 73, and 74 convert the digital signals Hᵢ, H_{q}, Vᵢ, and V_{q} into analog signals, respectively. The analog signals are input to the MZMs 81, 82, 83, and 84 corresponding to the DACs 71, 72, 73, and 74, respectively.

The LD 75 outputs transmission light with a predetermined frequency to the PBS 85. The PBS 85 separates the transmission light into an H-axis polarization component and a V-axis polarization component. The H-axis polarization component of the transmission light is input to each of the MZMs 81 and 82, and the V-axis polarization component of the transmission light is input to each of the MZMs 83 and 84.

Each of the MZMs 81, 82, 83, and 84 optically modulates the transmission light based on the analog signal input from the corresponding one of the DAC s 71, 72, 73, and 74. The H-axis polarization component and the V-axis polarization component of the optically modulated transmission light are input to the PBC 86. The PBC 86 polarization-combines the H-axis polarization component and the V-axis polarization component of the transmission light and outputs the combined light to the transmission line 10Z as an optical signal. Thus, the optical transmit device 10T transmits the optical signal.

The transmitting-end DSP 60 includes a mapping processing unit 61, a THP processing unit 62, a TS insertion unit 63, and the like. The THP processing unit 62 is an example of an encoding unit. Although omitted in FIG. 13, a frame processing unit, a forward error correction (FEC) encoding unit, and the like may be provided at a stage preceding the mapping processing unit 61, and a pulse shaping unit and the like may be provided at a stage subsequent to the TS insertion unit 63.

The mapping processing unit 61 maps the input data bit strings to symbols in a constellation in accordance with the modulation method, thereby generating the digital signals Hᵢ, H_{q}, Vᵢ, and V_{q}. The digital signals Hᵢ, H_{q}, Vᵢ, and V_{q} are output to the THP processing unit 62. The THP processing unit 62 precodes the digital signals Hᵢ, H_{q}, Vᵢ, and V_{q} by the THP. Thus, the intersymbol interference in the transmission line 10Z is compensated, and the data rate of the optical signal can be improved.

The TS insertion unit 63 inserts a training sequence (TS) into each of the digital signals Hᵢ, H_{q}, Vᵢ, and V_{q} output from the THP processing unit 62. The TS is used, for example, to detect the TS start position of a signal frame described later and determine the initial value of transmission line estimation. When the TS insertion unit 63 inserts a TS into each of the digital signals Hᵢ, H_{q}, Vᵢ, and V_{q}, the TS insertion unit 63 outputs the digital signals Hᵢ, H_{q}, Vᵢ, and V_{q} to the subsequent stage.

As described above, in the transmitting-end DSP 60 of the second embodiment, the TS insertion unit 63 is provided at the subsequent stage of the THP processing unit 62. By inserting the TS after the THP, the THP for the TS is avoided. Therefore, the loss of regularity of the signal waveform (more specifically, the pattern of the TS) of the digital signal is reduced depending on the condition of the transmission line 10Z. As a result, the TS is detected with high accuracy and can be used to estimate the initial sampling frequency error in the optical receive device 10R.

On the other hand, although not illustrated, in the transmitting-end DSP according to the first embodiment, the TS insertion unit is provided in a stage preceding the THP processing unit. In the case of such a configuration in which the TS is inserted before the THP, the THP is performed on the TS. Therefore, the regularity of the signal waveform (more specifically, the pattern of the TS) of the digital signal may be lost depending on the condition of the transmission line 10Z. Therefore, in the first embodiment, the detection of the TS is avoided, and the compensation of initial sampling frequency error is to be performed without relying on TS. As described above, the configuration of the transmitting-end DSP 60 included in the optical transmit device 10T according to the second embodiment is different from the configuration of the transmitting-end DSP included in the optical transmit device 10T according to the first embodiment.

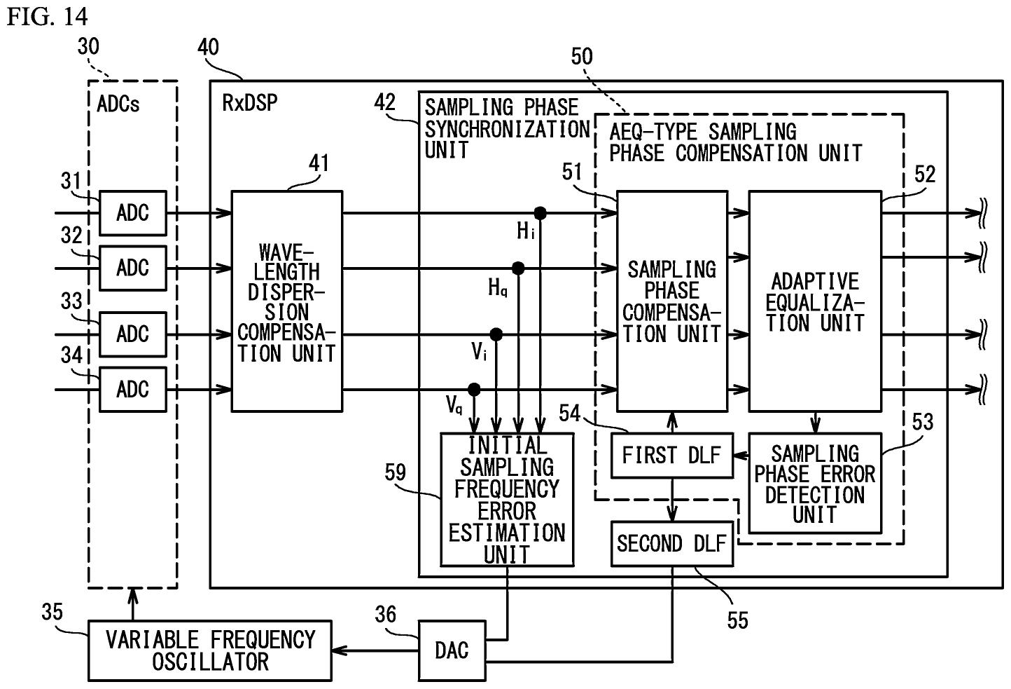

The optical receive device 10R (in particular, the sampling phase synchronization unit 42) according to the second embodiment will be described in detail with reference to FIG. 14. The same components as those of the optical receive device 10R according to the first embodiment are denoted by the same symbols, and detailed description thereof will be omitted.

The sampling phase synchronization unit 42 according to the second embodiment includes an initial sampling frequency error estimation unit 59 instead of the initial sampling phase error estimation unit 56 included in the sampling phase synchronization unit 42 according to the first embodiment. The initial sampling frequency error estimation unit 59 estimates the sampling frequency error of the digital signal in the initial period (for example, at the time of starting the operation of the optical receive device 10R or at the time of restarting the optical receive device 10R). The sampling frequency error estimated by the initial sampling frequency error estimation unit 59 is not input to the second DLF 55 but is input to the DAC 36.

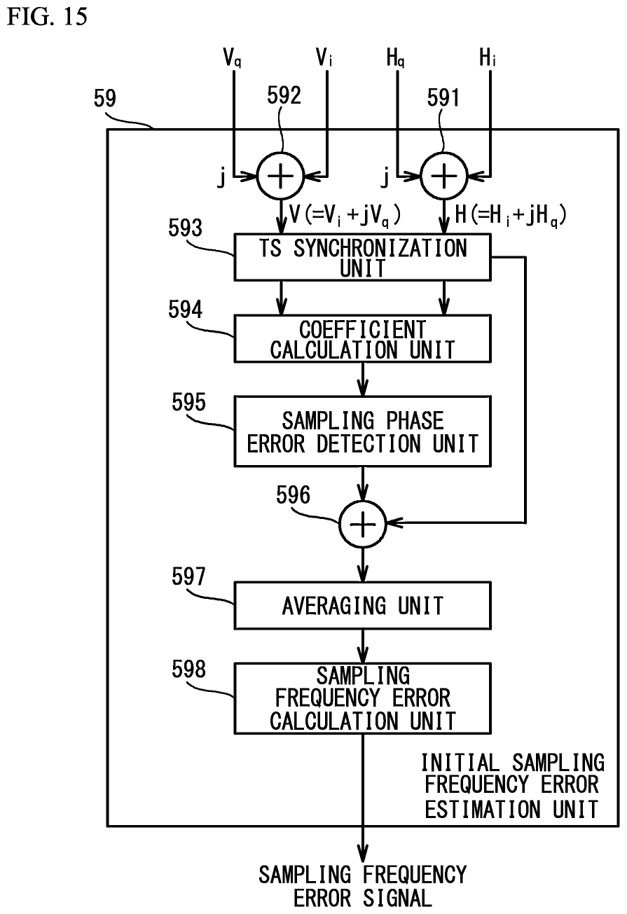

The details of the initial sampling frequency error estimation unit 59 will be described with reference to FIG. 15 to FIG. 18.

First, as illustrated in FIG. 15, the initial sampling frequency error estimation unit 59 includes two adder circuits 591 and 592 that are arranged in parallel, a TS synchronization unit 593, a coefficient calculation unit 594, and a sampling phase error detection unit 595. The initial sampling frequency error estimation unit 59 includes an adder circuit 596, an averaging unit 597, and a sampling frequency error calculation unit 598. A buffer may be provided in a stage preceding the TS synchronization unit 593.

The adder circuits 591 and 592 are basically the same as the adder circuits 561 and 562 described in the first embodiment, and thus detailed description thereof will be omitted. The initial sampling frequency error estimation unit 59 may be configured not to include the coefficient calculation unit 594, the sampling phase error detection unit 595, or the adder circuit 596. This reduces the processing load of the initial sampling frequency error estimation unit 59. On the other hand, the initial sampling frequency error estimation unit 59 includes the coefficient calculation unit 594, the sampling phase error detection unit 595, and the adder circuit 596, and thus can estimate the sampling frequency error with high accuracy.

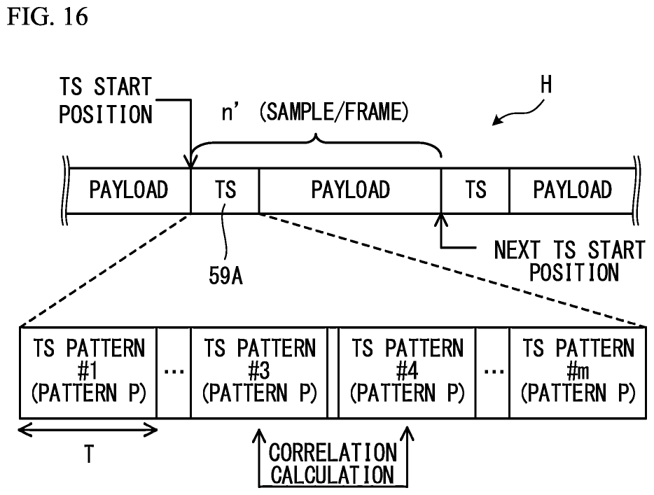

The TS synchronization unit 593 estimates a TS start position, which is a start position of a TS for each of the digital signal H read from the adder circuit 591 and the digital signal V read from the adder circuit 592, and establishes synchronization of the TS included in each of the digital signals H and V. For example, as illustrated in FIG. 16, the digital signal H includes a plurality of signal frames, with one frame from the TS start position to the next TS start position.

A TS 59A of the signal frame includes m TS patterns #1, . . . , #m at a fixed repetition interval T. The TS patterns #1, . . . , #m are known patterns P that are the same as each other.

The TS synchronization unit 593 has a prior knowledge of the TS pattern in the TS 59A, calculates correlations between various TS patterns such as a correlation between two continuous TS patterns #3 and #4 based on the structure, and determines a reading position from the adder circuit 591 when the correlation is the highest as the TS start position. By such calculation, the TS synchronization unit 593 determines a plurality of TS start positions, and calculates the number of samples “n′”, which is an integer, as the number of samples from a TS start position to the next TS start position. The number of samples “n′” is larger than the number of samples “n” defined by the frame format when the sampling frequency at the receiving end is higher than that at the transmitting end, and is less than the number of samples “n” when the sampling frequency at the receiving end is lower than that at the transmitting end.

Further, when the TS synchronization unit 593 determines the TS start position, the TS synchronization unit 593 acquires the TS pattern included in the digital signal H based on the determined TS start position, and outputs the acquired TS pattern to the coefficient calculation unit 594 as the receiving-end TS pattern. The digital signal Vis basically the same as the digital signal H, and thus detailed description thereof will be omitted. The structure of the TS pattern and the determination of the start position described above are merely examples, and the present disclosure is not limited to such a structure and start position.

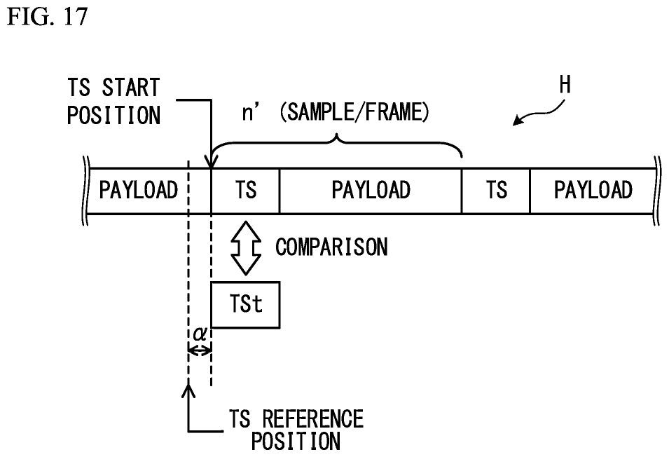

As illustrated in FIG. 17, the coefficient calculation unit 594 and the sampling phase error detection unit 595 calculate a difference “a” between the TS reference position, which is the TS synchronization position, and the TS start position by comparing the receiving-end TS pattern with a known transmitting-end TS pattern (denoted by TSt in FIG. 17) inserted at the transmitting end.

For example, the coefficient calculation unit 594 calculates a channel estimation value in the time domain by performing channel estimation using the minimum mean square error (MMSE) method or the like for minimizing a square error based on the receiving-end TS pattern and the transmitting-end TS pattern. This can be used as the initial value of the tap coefficient of the 2×2 MIMO type FIR filter in the adaptive equalization unit 52. The coefficient calculation unit 594 outputs the channel estimation result to the adaptive equalization unit 52 and also to the sampling phase error detection unit 595. In FIG. 15, the output to the adaptive equalization unit 52 is omitted.

The sampling phase error detection unit 595 calculates the difference “a” based on the channel estimation value supplied from the coefficient calculation unit 594. More specifically, the sampling phase error detection unit 595 calculates a group delay value, which is an average delay time of the 2×2 MIMO FIR filter, based on the channel estimation value calculated by the coefficient calculation unit 594, that is, the initial value of the tap coefficient. The group delay value can be calculated by converting the coefficient of the FIR filter into a frequency domain and obtaining the differential of its phase characteristic. By calculating the group delay value, the sampling phase error detection unit 595 can calculate in which position the position of the TS included in the actual received signal with respect to the TS start position exists, that is, the difference after the decimal point between the numbers of samples corresponding to the sampling phase errors. As described above, the sampling phase error detection unit 595 can calculate the difference “a” by performing the same calculation as the sampling phase error detection unit 53 in the AEQ-type sampling phase compensation unit 50. By using both the number of samples “n′”and the difference “α”, the number of samples per frame included in the received signal can be calculated with decimal precision, and the estimation accuracy of the frequency error described later can be improved as compared with the case of using only “n′”. The adder circuit 596 adds the difference “α” of the decimal sample number to the integer sample number “n′” and outputs the sample number “n′+α” to the averaging unit 597.

The averaging unit 597 averages the various numbers of samples “n′+α” output from the adder circuit 596. Specifically, the various sample numbers “n′+α” are added, and the added value is divided by the number of outputs of the sample numbers. This can reduce the variation in the number of samples “n′+α”. The averaging unit 597 averages the number of samples “n′+α”, and outputs the number of samples after averaging to the sampling frequency error calculation unit 598 as the number of samples “n′”.

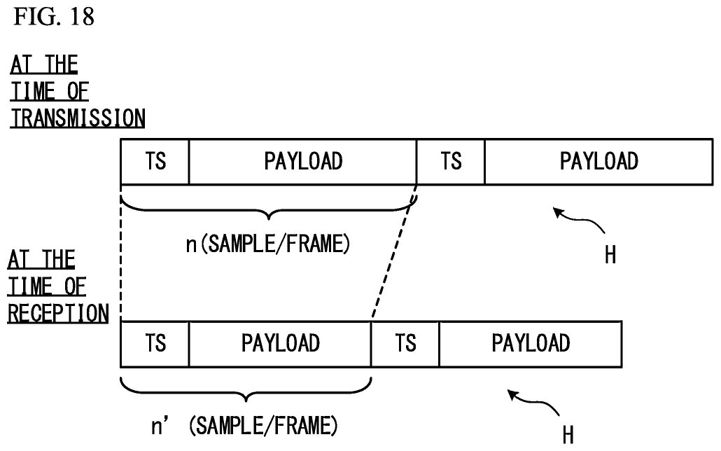

The sampling frequency error calculation unit 598 uses the number of samples “n′” output from the averaging unit 597 and calculates a sampling frequency error signal for updating the current sampling frequency to a value obtained by multiplying the current sampling frequency by a predetermined value “n/n′” obtained by dividing the number of samples “n” by the number of samples “n′”. For example, as illustrated in FIG. 18, the digital signal H having the number of samples “n” per frame at the time of transmission becomes the digital signal H having the number of samples “n′” per frame at the time of reception. In this case, if the sampling frequency is multiplied by “n/n′”, the sampling frequencies match between transmission and reception. The sampling frequency error calculation unit 598 compensates for the errors in the sampling frequencies by outputting the sampling frequency error signal for performing such control to the DAC 36. Note that a difference between the numbers of samples may be used instead of the ratio between the numbers of samples.

As described above, the optical transmit device 10T according to the second embodiment is different from the optical transmit device 10T according to the first embodiment in that the TS insertion unit 63 for inserting a TS is provided at the subsequent stage of the THP processing unit 62 that performs the THP. Thus, the TS does not pass through the THP processing unit 62, and therefore, the regularity of the TS is prevented from being changed by the THP. As a result, the optical receive device 10R according to the second embodiment can detect the TS from the digital signal. The optical receive device 10R can improve the accuracy of sampling frequency compensation based on the detected TS.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention. For example, instead of the DSP described above, a field programmable gate array (FPGA) or an application specific integrated circuit (ASIC) may be adopted.

What is claimed is:

1. An optical receive device comprising:
a coherent receiver that outputs an electrical analog signal corresponding to an optical signal;
a converter that converts the electrical analog signal into a digital signal;
a scrambler that scrambles a differential group delay (DGD) of the digital signal; and
an adjustment unit that receives the digital signal output by the scrambler as an input and adjusts one or both of a sampling frequency and a sampling phase of the converter based on a power envelope (PE) method.

2. The optical receive device according to claim 1, further comprising a decoding unit that decodes a digital signal precoded based on a Tomlinson-Harashima precoding (THP) technique.

3. The optical receive device according to claim 1,
wherein the coherent receiver receives the optical signal transmitted by using a predetermined technique for reducing intersymbol interference of a transmission line,
wherein the scrambler compensates for a frequency error between the digital signal and sampling before compensating for the sampling phase, and outputs a predetermined signal obtained by randomly changing one or both of a first variable and a second variable, the first variable being related to polarization rotation of the optical signal, the second variable being related to a group delay time difference, and
wherein the adjustment unit detects a sampling phase error of the predetermined signal based on a coefficient updated by adaptive equalization processing on the digital signal output by the converter and the PE method, and adjusts one or both of the sampling frequency and the sampling phase based on the sampling phase error.

4. The optical receive device according to claim 3, wherein the scrambler outputs a predetermined signal obtained by randomly changing both the first variable and the second variable.

5. The optical receive device according to claim 4, wherein the scrambler includes:
a first multi-input multi-output (MIMO) filter in which a first calculation result based on a transfer function for calculating an amount of the polarization rotation is independently set;
and a second MIMO filter in which a second calculation result based on a transfer function for calculating an amount of the group delay time difference is independently set.

6. The optical receive device according to claim 4, wherein the scrambler includes a single multi-input multi-output (MIMO) filter in which a third calculation result based on a dependent product of a transfer function for calculating an amount of the polarization rotation and a transfer function for calculating an amount of the group delay time difference is set.

7. An optical transmission system including: an optical transmit device that applies a predetermined technique for reducing intersymbol interference of a transmission line to a first digital signal and transmits an optical signal corresponding to the first digital signal, and an optical receive device that receives the optical signal,
wherein the optical receive device includes:
a coherent receiver that receives the optical signal and outputs an electrical analog signal corresponding to the optical signal;
a converter that converts the electrical analog signal into a second digital signal;
a scrambler that scrambles a differential group delay (DGD) of the second digital signal; and
an adjustment unit that receives a digital signal output by the scrambler as an input and adjusts one or both of a sampling frequency and a sampling phase of the converter based on a power envelope (PE) method.

8. The optical transmission system according to claim 7,
wherein the optical transmit device includes an encoding unit that precodes the first digital signal based on a Tomlinson-Harashima precoding (THP) technique, and
wherein the optical receive device includes a decoding unit that decodes the second digital signal based on the THP technique.

9. The optical transmission system according to claim 7,
wherein the scrambler compensates for a frequency error between the second digital signal and sampling before compensating for the sampling phase, and outputs a predetermined signal obtained by randomly changing one or both of a first variable and a second variable, the first variable being related to polarization rotation of the optical signal, the second variable being related to a group delay time difference, and
wherein the adjustment unit detects a sampling phase error of the predetermined signal based on a coefficient updated by adaptive equalization processing on the second digital signal output by the converter and the PE method, and adjusts one or both of the sampling frequency and the sampling phase based on the sampling phase error.

10. An optical transmission system including an optical transmit device that transmits an optical signal, and an optical receive device that receives the optical signal,
wherein the optical transmit device includes:
a coding unit that precodes an electrical first digital signal using a predetermined technique for reducing intersymbol interference of a transmission line;
an insertion unit that inserts a training sequence including a plurality of identical patterns to the first digital signal after being precoded, and
a modulator that modulates, into the optical signal, the first digital signal to which the training sequence has been inserted,
wherein the optical receive device includes:
a coherent receiver that receives the optical signal and outputs an electrical analog signal corresponding to the optical signal,
a converter that converts the electrical analog signal into a second digital signal,
a sampling phase compensator that compensates for a sampling phase of the optical signal based on a coefficient updated by adaptive equalization processing on the second digital signal, and
a sampling frequency error estimation unit that determines a start position of the training sequence included in the second digital signal based on correlation of the identical patterns before compensating for the sampling phase, and estimates a sampling frequency error of the converter based on a sample number difference between a first sample number based on the start position and a second sample number of the training sequency at the optical transmit device and a sample number ratio between the first sample number and the second sample number.

11. The optical transmission system according to claim 10, wherein the sampling frequency error estimation unit compares a first pattern of the training sequence included in the second digital signal with a second pattern of the training sequence inserted into the first digital signal, calculates a difference between a start position of the training sequence and a reference position, and compensates for the sampling frequency of the converter based on the sample number difference or the sample number ratio and the difference.

12. The optical receive device according to claim 3, wherein the predetermined technique includes a THP technique.

13. The optical transmission system according to claim 7, wherein the predetermined technique includes a THP technique.

14. The optical transmission system according to claim 10, wherein the predetermined technique includes a THP technique.
